(19) United States
(12) Patent Application Publication
(10) Pub. No.: US 2021/0176387 A1
(43) Pub. Date: Jun. 10, 2021

(54) ELECTRONIC APPARATUS AND ACTION CAMERA

(71) Applicant: SZ DJI TECHNOLOGY CO., LTD., Shenzhen (CN)

(72) Inventors: Dong LI, Shenzhen (CN); Qiusheng YANG, Shenzhen (CN)

(21) Appl. No.: 17/182,215

(22) Filed: Feb. 22, 2021

Related U.S. Application Data
(63) Continuation of application No. PCT/CN2018/103651, filed on Aug. 31, 2018.

(51) Int. Cl. H04N 5/232; H04N 5/225; H01Q 1/36; H04B 1/38

(52) U.S. Cl. CPC H04N 5/232; H04B 1/38; H01Q 1/36; H04N 5/2252

(57) ABSTRACT

An electronic apparatus includes a wireless communication assembly, a flexible printed circuit, and a reinforcement member. The reinforcement member is arranged at the flexible printed circuit and includes a conductive member. The reinforcement member is electrically connected to the wireless communication assembly. The reinforcement member is configured to convert a first electrical signal from the wireless communication assembly to a radiated electromagnetic wave and convert a received electromagnetic wave to a second electrical signal for sending to the wireless communication assembly.

### CROSS-REFERENCE TO RELATED APPLICATION

This application is a continuation of International Application No. PCT/CN2018/103651, filed Aug. 31, 2018, the entire content of which is incorporated herein by reference.

### TECHNICAL FIELD

The present disclosure generally relates to the portable equipment field and, more particularly, to an electronic apparatus and an action camera.

### BACKGROUND

With development of technology, more and more portable apparatuses can be connected wirelessly to the outside world. As such, the portable apparatus may ensure its portability and transmit a signal and data.

Currently, to connect the portable apparatus wirelessly to the outside world, a wireless communication assembly, which is configured to transmit a wireless signal, is usually arranged at the portable apparatus. In general, the wireless communication assembly includes an antenna radiation circuit. The antenna radiation circuit can be configured to transmit a radio wave to the outside or receive a radio wave. To avoid impacting the appearance of the portable apparatus, the antenna radiation circuit is arranged inside the portable apparatus.

However, to allow the wireless communication assembly to have a relatively good signal, the size of the antenna radiation circuit is usually relatively large. Therefore, the antenna radiation circuit takes the internal space of the portable apparatus to affect a layout of another element in the internal space. If both layout requirements of the antenna radiation circuit and the internal space are satisfied, the whole size of the portable apparatus is increased to affect the portability of the portable apparatus.

### SUMMARY

Embodiments of the present disclosure provide an electronic apparatus including a wireless communication assembly, a flexible printed circuit, and a reinforcement member. The reinforcement member is arranged at the flexible printed circuit and includes a conductive member. The reinforcement member is electrically connected to the wireless communication assembly. The reinforcement member is configured to convert a first electrical signal from the wireless communication assembly to a radiated electromagnetic wave and convert a received electromagnetic wave to a second electrical signal for sending to the wireless communication assembly.

Embodiments of the present disclosure provide an action camera including a housing body, an image sensor, a wireless communication assembly, a flexible printed circuit, and a reinforcement member. The housing body includes an internal chamber. The reinforcement member is arranged at the flexible printed circuit and includes a conductive member. The reinforcement member is electrically connected to the wireless communication assembly. The reinforcement member is configured to convert a first electrical signal from the wireless communication assembly to a radiated electromagnetic wave and convert a received electromagnetic wave to a second electrical signal for sending to the wireless communication assembly. The image sensor, the wireless communication assembly, the flexible printed circuit, and the reinforcement member are located in the internal chamber.

### BRIEF DESCRIPTION OF THE DRAWINGS

FIG. 1 is a schematic structural diagram of an electronic apparatus according to some embodiments of the present disclosure.

FIG. 2 is a schematic diagram showing a connection of a flexible printed circuit and a reinforcement member of the electronic apparatus according to some embodiments of the present disclosure.

FIG. 3 is a schematic structural diagram showing the reinforcement member of the electronic apparatus according to some embodiments of the present disclosure.

FIG. 4 is a schematic structural diagram showing an internal circuit of the electronic apparatus along a direction according to some embodiments of the present disclosure.

FIG. 5 is a schematic structural diagram showing the internal circuit of the electronic apparatus along another direction according to some embodiments of the present disclosure.

FIG. 6 is a schematic diagram showing an appearance of an action camera according to some embodiments of the present disclosure.

FIG. 7 is a schematic diagram showing a connection of a flexible printed circuit and a reinforcement member of the action camera according to some embodiments of the present disclosure.

### REFERENCE NUMERALS

1 Wireless communication assembly
2 Flexible printed circuit
3 Reinforcement member
4 Housing body
5 Second circuit board
6 Electrical connection wire
7 Conductive elastic plate
11 First circuit board
12 Wireless transceiver
21 First key
22 Second Key
23 Microphone
31 Body
32 Radiation member
311 First bent member
312 Second bent member

### DETAILED DESCRIPTION OF THE EMBODIMENTS

To make purposes, technical solutions, and advantages of embodiments of the present disclosure clearer, the technical solutions of embodiments of the present disclosure are described in detail in connection with the accompanying drawings. Described embodiments are some embodiments of the present disclosure but not all embodiments. Based on embodiments of the present disclosure, all other embodiments obtained by those of ordinary skill in the art without creative efforts are within the scope of the present disclosure.

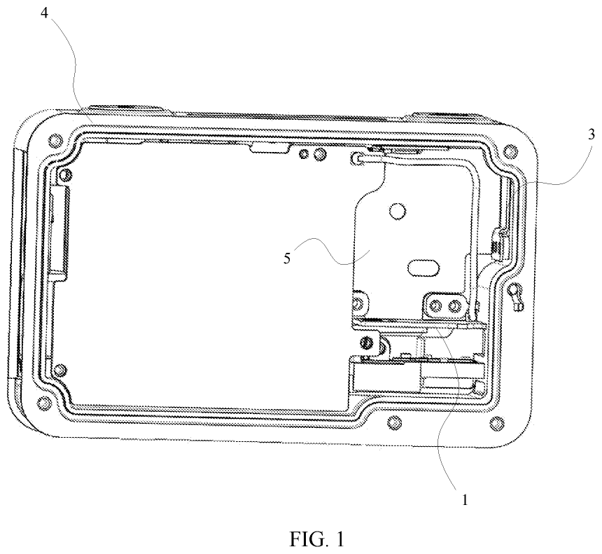

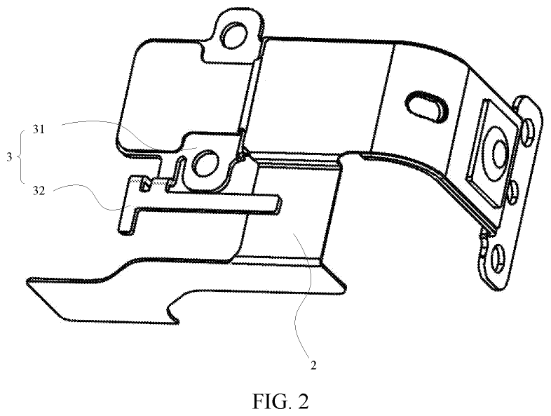

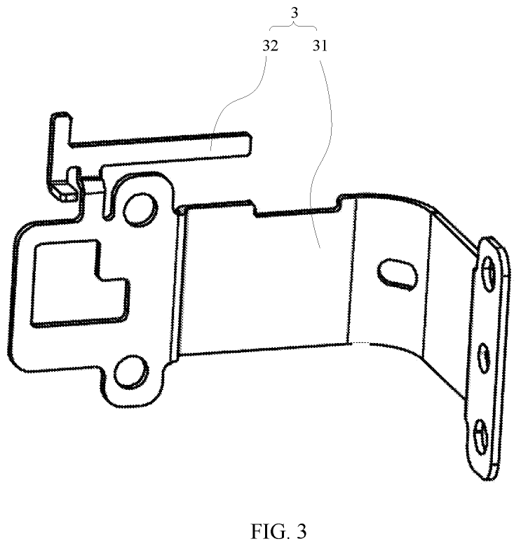

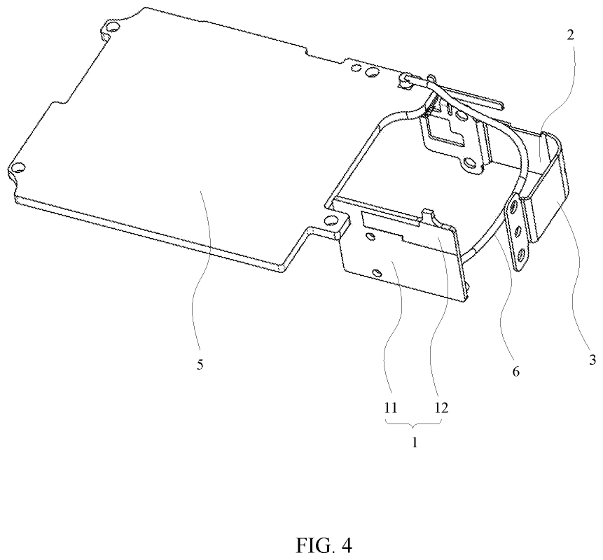

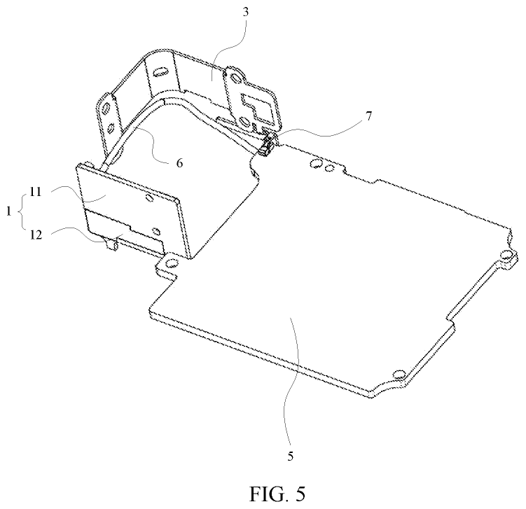

FIG. 1 is a schematic structural diagram of an electronic apparatus according to some embodiments of the present disclosure. FIG. 2 is a schematic diagram showing a connection of a flexible printed circuit and a reinforcement member of the electronic apparatus according to some embodiments of the present disclosure. FIG. 3 is a schematic structural diagram showing the reinforcement member of the electronic apparatus according to some embodiments of the present disclosure. FIG. 4 is a schematic structural diagram showing an internal circuit of the electronic apparatus along a direction according to some embodiments of the present disclosure. FIG. 5 is a schematic structural diagram showing the internal circuit of the electronic apparatus along another direction according to some embodiments of the present disclosure. As shown in FIG. 1 to FIG. 5, the electronic apparatus consistent with embodiments of the present disclosure includes a wireless communication assembly 1, a flexible printed circuit (FPC) 2, and a reinforcement member 3. The reinforcement member 3 is arranged at the FPC 2. The reinforcement member 3 may include a conductive member. The reinforcement member 3 is electrically connected to the wireless communication assembly 1 and is configured as an antenna radiation circuit of the wireless communication assembly 1.

In some embodiments, the electronic apparatus may include a digital camera, a recorder, a tablet, or an action camera. Some electronic devices inside the electronic apparatus may be distributed relatively scattered or located in a relatively narrow space. To arrange these electronic devices, the FPC 2 or another flexible electrical connection member may be arranged inside the electronic apparatus. Some electronic devices may be arranged at the FPC 2. Since the FPC 2 may have relatively good deformability, the FPC 2 may be configured to electrically connect electronic devices relatively far away from each other or may be suitable for a space with a relatively complex shape or a relatively small volume. In general, to fix or structurally reinforce the flexible electrical connection member such as the FPC 2, a reinforcement member 3 may be arranged in the electronic apparatus. The reinforcement member 3 may be arranged at the FPC 2. The reinforcement member 3 may usually include a structural member with relatively good rigidity. Thus, the FPC 2 may be fixed and attached to the reinforcement member 3 to represent a certain integrated shape. The reinforcement member 3 may be configured as a racket of the FPC 2 to stably fix and support the FPC 2, which is soft and easy to deform. The reinforcement member 3 may further avoid a displacement, shaking, and loosening of the FPC 2 due to lack of fixation and positioning. In some embodiments, a portion of the FPC 2 may be arranged floating or have a certain flexible deformation and may be connected to another electrical circuit or another electronic device. Another portion of the FPC 2 may be supported by the reinforcement member 3.

To transmit information and data to the outside world, a device and an assembly configured for communication may be arranged in the electronic apparatus. To ensure the portability of the electronic apparatus, a wireless communication assembly 1 may be arranged in the electronic apparatus. As such, the electronic apparatus may implement the wireless communication function by using the radio wave. Since the internal space of the electronic apparatus is relatively narrow, the reinforcement member 3 may be composed of a conductive material, and the wireless communication assembly 1 may be electrically connected to the reinforcement member 3. Thus, the reinforcement member 3 may be configured as the antenna radiation circuit of the wireless communication assembly 1. The wireless signal transmitted by the wireless communication assembly 1 may be radiated to the outside by the reinforcement member 3. A wireless signal from the outside may be received by the reinforcement member 3 and transmitted to the wireless communication assembly 1 to ensure the normal communication and the signal transmission of the wireless communication assembly 1. As such, by using the reinforcement member 3 as the antenna radiation circuit of the wireless communication assembly 1, the structural element and internal space of the electronic apparatus may be effectively used to cause the structure of the electronic apparatus to be relatively tight.

In general, to ensure the reinforcement member 3 to have sufficient rigidity and electrical conductivity, the reinforcement member 3 may include a metal member. In some other embodiments, the reinforcement member 3 may include a conductive material, such as conductive plastic, which is not limited here.

In some embodiments, for the reinforcement member 3 to have normal wireless signal reception and transmission function, the electronic apparatus further includes a housing body 4 that allows waves to pass through. The housing body 4 includes a hollow internal chamber. The FPC 2, the reinforcement member 3, and the wireless communication assembly 1 are located in the internal chamber. As such, the FPC 2, the reinforcement member 3, and the wireless communication assembly 1 may be accommodated and protected by the housing body 4. Since a radio wave may penetrate the housing body 4, the reinforcement member 3 may normally receive or transmit the wireless signal to ensure a normal communication function of the wireless communication assembly 1. The housing body 4 may include a material that may let the radio wave penetrate and have a certain structural strength, such as plastic or glass fiber.

In some embodiments, the reinforcement member 3 may be fixed to an inner wall of the housing body 4. As such, the reinforcement member 3 may have a determined position inside the electronic apparatus, which may well support and reinforce the FPC 2. The reinforcement member 3 may be fixed on the inner wall of the housing body 4. In some embodiments, a mounting hole, a mounting slot, or a snap connection structure may be arranged at the reinforcement member 3. The reinforcement member 3 may be connected to the inner wall of the housing body 4 by using a snap connection, a threaded fastening member, or another connection manner.

To ensure the antenna radiation circuit formed by the reinforcement member 3 have a relatively good signal strength and communication quality, the reinforcement member 3 may need to have a shape and an arrangement position that are easy to radiate an electromagnetic wave. For example, the reinforcement member 3 may be located at a position inside the electronic apparatus and close to the housing body 4 of the electronic apparatus to facilitate transmission of electromagnetic wave to the outside of the electronic apparatus or reception of electromagnetic wave from the outside of the electronic apparatus. The reinforcement member 3 may have one of a plurality of shapes, for example, a shape with an open end, such that electromagnetic wave can be radiated to the outside from the open end of the reinforcement member 3. The reinforcement member 3 and the whole structure of the electronic apparatus are described in detail below.

The reinforcement member 3 can have two functions, i.e., supporting the FPC 2 and functioning as an antenna radiation circuit of the wireless communication assembly 1. Therefore, to avoid mutual interference between the two functions of the reinforcement member 3, the reinforcement member 3 and the FPC 2 may be insulated between each other. Thus, the reinforcement member 3 may only provide physical support to the FPC 2 according to its own structure and shape and may not be electrically connected to the FPC 2. Therefore, when the reinforcement member 3 transmits and radiates the signal of the wireless communication assembly 1, the electrical signal of the reinforcement member 3 may not be transmitted to the FPC 2 to interfere a signal transmission of the FPC 2. The electrical signal of the FPC 2 also may not be transmitted to the reinforcement member 3 to cause a short circuit or a leakage of the FPC 2.

In some embodiments, to realize the insulation between the FPC 2 and the reinforcement member 3, a side of the FPC 2 arranged with a conductive wire may be arranged to face away from the reinforcement member 3 to avoid contact between the conductive wire and the surface of the reinforcement member 3 that causes conduction. In addition, when the FPC 2 is connected to the reinforcement member 3, the FPC 2 may be adhered to the reinforcement member 3 by an insulating adhesive to further improve the insulation between the FPC 2 and the reinforcement member 3.

When the reinforcement member 3 is configured as a support and reinforcement structure of the FPC 2, the reinforcement member 3 may only need to support the FPC 2, as long as the reinforcement member 3 has a shape matching the shape of the FPC 2. However, when the reinforcement member 3 is configured as the antenna radiation circuit, to ensure relatively good signal quality, the reinforcement member 3 may need to have a relatively large size or there is a certain requirement for the shape. In some embodiments, the FPC 2 may cover a portion of the outer surface of the reinforcement member 3. The FPC 2 may only cover a portion of the outer surface of the reinforcement member 3. A remaining portion of the outer surface of the reinforcement member 3 that is not covered by the FPC 2 may have a shape that facilitates reception and transmission of radio wave. In some other embodiments, a surface covered by the FPC 2 may coincide with the outer surface of the reinforcement member 3. As such, the FPC 2 may cover the whole outer surface of the reinforcement member 3.

When the FPC 2 only covers a portion of the outer surface of the reinforcement member 3, the portion of the outer surface of the reinforcement member 3 that is not covered by the FPC 2 may be used to improve the quality of the signal reception or the signal transmission of the radio wave. In some embodiments, the reinforcement member 3 includes a body 31 and a radiation member 32. The body 31 may be covered by the FPC 2 and may be configured as a support and reinforcement structure of the FPC 2. The radiation member 32 is located outside the coverage area of the FPC 2 and may be configured to realize the radiation of the radio wave or improve the signal quality of the reinforcement member 3. An end of the radiation member 32 is connected to the body 31. Another end of the radiation member 32 includes a free end extending toward the outside of the body 31. As such, the radiation member 32 may form an open shape, which can facilitate transmission of electromagnetic wave. Thus, the reinforcement member 3 may be electrically connected to the wireless communication assembly 1. The electrical signal generated by the wireless communication assembly 1 may reach the radiation member 32 through the body 31 of the reinforcement member 3 and may be radiated toward the outside by the radiation member 32 in a form of the electromagnetic wave. An electromagnetic wave from the outside may be easily received and collected by the free end of the radiation member 32.

Although the reinforcement member 3 includes the body 31, the radiation member 32, etc., and the main function of the radiation member 32 is to radiate the radio wave or improve the wireless signal quality, it does not mean that the body 31 does not have the ability to radiate the electromagnetic wave. In fact, when the body 31 covers the FPC 2 and is configured as the support and reinforcement structure of the FPC 2, the body 31 may also be a main part of the antenna radiation circuit and may perform radiation of the radio wave.

Relative size of the radiation member 32 relative to the body 31 of the reinforcement member 3 and the shape of the radiation member 32 itself may each be one of a plurality of different types. For example, the radiation member 32 may be arranged at one of different positions, such as a side of the body of the reinforcement member 3. A direction that the free end of the radiation member 32 extends toward the outside may be parallel to the direction of the whole length of the body 31 of the reinforcement member 3 or may have a certain included angle with the body 31 of the reinforcement member 3. The radiation member 3 may also have another antenna shape.

In some embodiments, to reduce the weight and the space usage of the reinforcement member 3, the reinforcement member 3 may include a plate-shaped member. The FPC 2 may cover at least a portion of a plate surface of the reinforcement member 3. Since the reinforcement member 3 includes the plate-shaped member, the reinforcement member 3 may provide a relatively large attachment area for the FPC 2 to facilitate the connection between the FPC 2 and the reinforcement member 3. In addition, since the weight of the FPC 2 may be relatively small, a plate-shaped member with a relatively thin thickness may be configured as the reinforcement member 3, which may support the FPC 2 and cause the reinforcement member 3 to have a relatively small weight and volume. In addition, the reinforcement member 3 may include another structure and another form, which is not limited here.

In some embodiments, to realize functions of the FPC 2, the FPC 2 may include at least one of a key circuit, a microphone circuit, a loudspeaker circuit, an indicator circuit, or a vibration motor circuit. The key circuit may include a key for a user to push to perform a finger input operation. The microphone circuit may include a microphone, which may be configured to collect sound information from the outside of the electronic apparatus. The loudspeaker circuit may include a loudspeaker, which may be configured to cause the electronic apparatus to output sound. The indicator circuit may include one or a plurality of different indicators. The indicators may be configured to perform a corresponding alert to the user. The vibration motor circuit may include a vibration motor, which may cause the electronic apparatus to perform a vibration alert. The above-described circuits may exist individually at the FPC 2, or several different circuits may be combined together to be arranged at the FPC 2, which is not limited here.

In some embodiments, to realize the wireless communication between the electronic apparatus and the outside world, the wireless communication assembly 1 includes a first circuit board 11 and a wireless transceiver 12 located at the first circuit board 11. The reinforcement member 3 may be electrically connected to the wireless transceiver 12. As such, the first circuit board 11 may be fixed inside the electronic apparatus by a fixed structure, such as the bracket. The wireless transceiver 12 may be arranged at the first circuit board 11 and may be configured to receive and transmit the wireless signal. The antenna radiation circuit configured as the wireless communication assembly may be electrically connected to the first circuit board 11 by a connection wire or an electrical connector to be connected to the wireless transceiver 12. The wireless transceiver 12 may be electrically connected to the reinforcement member 3 by using the first circuit board 11 as a medium. The first circuit board 11 may include a printed circuit board (PCB).

In some embodiments, the wireless communication assembly 1 may communicate with the outside world wirelessly via a wireless fidelity (Wi-Fi) signal. Thus, the wireless transceiver 12 may include a Wi-Fi transceiver. The wireless communication assembly 1 may also receive and transmit the wireless signal and data via another communication manner, for example, Bluetooth, the 3rd-generation mobile communication technology (3G), or the 4th generation mobile communication technology (4G), which is not limited here.

To reduce interference when the wireless communication assembly 1 performs communication, the first circuit board 11 of the wireless communication assembly 1 may include an individual circuit board, the size of the first circuit board 11, and the arrangement position of the first circuit board 11 inside the electronic apparatus may be limited. In some other embodiments, to facilitate the electrical connection between the reinforcement member 3 and the wireless communication assembly 1, the electronic apparatus may include a second circuit board 5. The reinforcement member 3 may be electrically connected to the second circuit board 5. The second circuit board 5 and the first circuit board 11 may be connected via an electrical connection wire 6. No matter where the position of the first circuit board 11 is, the reinforcement member 3 may be first connected to the second circuit board 5 and then may be electrically connected to the first circuit board 11 of the wireless communication assembly 1 via the second circuit board 5. As such, the type and arrangement position of the wireless communication assembly 1 may be relatively flexible, which facilitates the layout and arrangement of the internal devices of the electronic apparatus.

In addition, the second circuit board 5 may have a relatively large size. Thus, the second circuit board 5 may be configured to directly fix the reinforcement member 3 to further support and position the reinforcement member 3.

In some embodiments, the second circuit board 5 may include a main circuit board of the electronic apparatus. As such, in addition to connect the reinforcement member 3 and the first circuit board 11 of the wireless communication assembly 1, a processor, a main controller, and another main functional circuit of the electronic apparatus may be arranged at the second circuit board 5.

In some embodiments, to connect the reinforcement member 3 to the second circuit board 5, a plurality of different electrical connection structures may be arranged between the second circuit board 5 and the reinforcement member 3. In some embodiments, for example, a conductive elastic plate 7 is arranged between the reinforcement member 3 and the second circuit board 5. An end of the conductive elastic plate 7 may be connected to the reinforcement member 3. Another end of the conductive elastic plate 7 may abut against a signal feed point of the second circuit board 5.

The reinforcement member 3 may not be directly fixed at the second circuit board 5 but may be fixed at another structure of the electronic apparatus. There may be a certain interval and distance between the reinforcement member 3 and the second circuit board 5. Therefore, the deformable conductive elastic plate 7 may be arranged between the reinforcement member 3 and the second circuit board 5. Two ends of the conductive elastic plate 7 may be connected to the reinforcement member 3 and the second circuit board 5, respectively. Since the conductive elastic plate 7 has a certain elasticity, a free length of the conductive elastic plate 7 may be longer than a distance between the reinforcement member 3 and the signal feed point of the second circuit board 5. As such, the conductive elastic plate 7 may abut against the signal feed point of the second circuit board 5 and provide electrical conduction between the reinforcement member 3 and the signal feed point of the second circuit board 5, to realize the reliable electrical connection between the reinforcement member 3 and the second circuit board 5.

In some embodiments, another conductive structure may be used to electrically connect the reinforcement member 3 and the second circuit board 5. For example, the reinforcement member 3 may directly contact the signal feed point of the second circuit board 5, or one various elastic or non-elastic conductive elements may be used to conduct the reinforcement member 3 and the second circuit board 5, which is not limited here.

To connect the second circuit board 5 and the first circuit board 11, the electrical connection wire 6 may have one of a plurality of different structures and be of one of different types. In some embodiments, the electrical connection wire 6 may include any one of a coaxial cable, a ribbon line, or a microstrip line. By taking the coaxial cable as the electrical connection wire 6 for example, an end of the coaxial cable may be connected to the signal feed point of the first circuit board 11. Another end of the coaxial cable may be connected to the second circuit board 5. As such, the second circuit board 5 may realize the signal transmission with the first circuit board 11 via the coaxial cable.

In some embodiments, the electronic apparatus includes the wireless communication assembly 1, the FPC 2, and the reinforcement member 3. The reinforcement member 3 is arranged at the FPC 2. The reinforcement member 3 may include a conductive member. The reinforcement member 3 may be electrically connected to the wireless communication assembly 1 and may be configured as the antenna radiation circuit of the wireless communication assembly 1. As such, by configuring the reinforcement member 3 as the antenna radiation circuit of the wireless communication assembly 1, the structure and the internal space of the electronic apparatus may be effectively used to cause the whole structure of the electronic apparatus to be relatively tight.

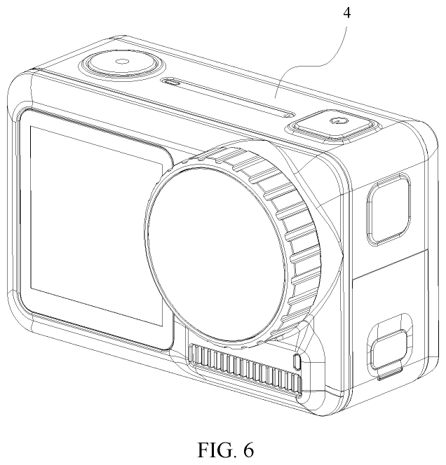

FIG. 6 is a schematic diagram showing an appearance of the action camera according to some embodiments of the present disclosure. In the action camera of embodiments of the present disclosure, the reinforcement member may also be configured as the antenna radiation circuit, which is configured to realize the wireless communication. The action camera of embodiments of the present disclosure may include a structure similar to the electronic apparatus above. As shown in FIG. 1 to FIG. 6, the action camera also includes the housing body 4, the wireless communication assembly 1, the FPC 2, the reinforcement member 3, and an image sensor (not shown in the drawings). The housing body 4 includes an internal chamber. The image sensor, the wireless communication assembly 1, the FPC 2, and the reinforcement member 3 are located in the internal chamber. The reinforcement member 3 is arranged at the FPC 2. The reinforcement member 3 may include the conductive member. The reinforcement member 3 may be electrically connected to the wireless communication assembly 1 and may be configured as the antenna radiation circuit of the wireless communication assembly 1.

In some embodiments, the housing body 4 of the action camera may be sealed and waterproof and may be formed by a material that can let the radio wave penetrate. As such, the wireless communication assembly 1 accommodated in the internal chamber of the housing body 4 may realize a wireless communication connection with the outside world by penetrating the housing body 4. To support and structurally reinforce the FPC 2, the reinforcement member 3 may be arranged inside the action camera. The reinforcement member 3 may be electrically connected to the wireless communication assembly 1 and may be configured as the antenna radiation circuit to receive and transmit the radio wave. The wireless communication assembly 1, the FPC 2, and the reinforcement member 3 may include similar structures, functions, and working principles as above, the descriptions of which are not repeated here. In addition, the action camera may further include one or more functional assemblies including the image sensor.

In some embodiments, the action camera may also include the first circuit board 11 and the second circuit board 5. The wireless communication assembly 1 may be arranged at the first circuit board 11. The second circuit board 5 may be configured as the main circuit board of the action camera. As such, the wireless communication assembly 1 and the main circuit board may be independent of each other, which may improve anti-interference ability and electromagnetic compatibility of the wireless communication assembly 1 to improve the wireless signal quality.

The first circuit board 11 and the second circuit board 5 that is configured as the main circuit board may include a plurality of arrangement manners and relative positions. In some embodiments, for example, the first circuit board 11 and the second circuit board 5 may face different directions. Since the main circuit board may need to have a relatively large size, the position of the second circuit board 5 may be limited in the housing body 4. For example, a direction of the plate surface of the second circuit board 5 may be parallel to a direction of the surface with the largest size of the housing body 4 of the action camera. The first circuit board 11 may be arranged at the second circuit board 5, that is, a position such as a side of the main circuit board. The plate surface direction of the first circuit board 11 and the plate surface direction of the second circuit board 5 may be different, for example, perpendicular to the second circuit board 5. As such, the first circuit board 11 may adapt to the relatively narrow internal space of the housing body 4 or may obtain a relatively good wireless signal quality.

Further, when the action camera includes members, such as the second circuit board 5 that is configured as the main circuit board, the plate surface direction of the second circuit board 5 may be parallel to the direction of the surface with the largest size of the housing body 4 of the action camera. Thus, the plate surface direction of the second circuit board 5 may be toward a front surface or a rear surface of the action camera. Therefore, in some embodiments, correspondingly, the image sensor may be arranged at the second circuit board 5. As such, the image sensor may be reliably fixed and positioned and be beneficial to be connected to another electronic device.

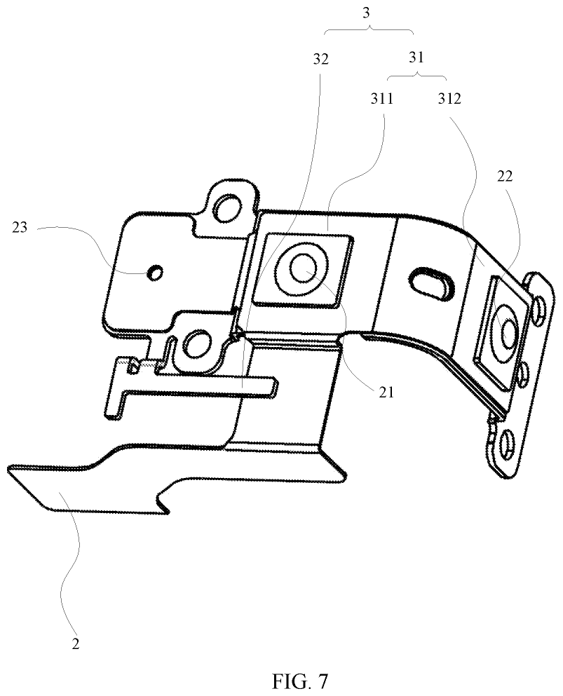

Since the internal space of the housing body 4 of the action camera is relatively tight, the reinforcement member 3 may include a bent structure. Thus, a relatively large extension length may be formed inside the relatively small internal space. FIG. 7 is a schematic diagram showing a connection of a flexible printed circuit and a reinforcement member of the action camera according to some embodiments of the present disclosure. As shown in FIG. 7, in some embodiments, the reinforcement member 3 includes a first bent member 311 and a second bent member 312 connected to the first bent member 311. The second bent member 312 may be bent to an angle relative to the first bent member 311. As such, a bend may exist between the second bent member 312 and the first bent member 311. The reinforcement member 3 may include at least two portions extending toward different directions. Although the whole length of the reinforcement member 3 may be relatively long, the reinforcement member 3 may be arranged inside the housing body 4 having a narrow space. The first bent member 311 and the second bent member 312 may be configured to arrange the FPC 2, that is, the first bent member 311 and the second bent member 312 may be configured as portions of the body 31 of the reinforcement member 3. The radiation member 32 of the reinforcement member 3 may be connected to one of the first bent member 311 or the second bent member 312. In some embodiments, the radiation member 32 may be connected to the first bent member 311.

Correspondingly, in some embodiments, the FPC 2 may cover the first bent member 311 and the second bent member 312. Thus, because of its deformability, the FPC 2 may be arranged at two different portions of the reinforcement member 3 having the included angle. When the internal space of the housing body 4 is relatively narrow, the FPC 2 may be still ensured to be set and arranged unfolded.

Further, an overall outer profile size of the reinforcement member 3 may mutually match with the space size enclosed by the inner walls of the housing body 4. In some embodiments, the first bent member 311 and the second bent member 312 may be fixed on the inner walls of different directions of the internal space. The reinforcement member 3 may be fixed on at least two inner walls of different directions of the internal space to be reliably fixed at the housing body 4. The first bent member 311 and the second bent member 312 may be fixed by using the same or different fixing manners. For example, the first bent member 311 may be fixed at a surface of the inner walls of the housing body 4 by a fastening member. The second bent member 312 may be fixed at another surface of the inner walls of the housing body 4 by a structure such as a snap slot. In some other embodiments, the first bent member 311 and the second bent member 312 both may be fixed at the inner walls of the housing body 4 by the fastening members.

In some embodiments, the overall shape of the internal space of the housing body 4 may be a square and includes two sides and a corner between the two sides. The first bent member 311 and the second bent member 312 may be fixed at different sides of the internal space, respectively, and the connection between the first bent member 311 and the second bent member 312 may be located at the corner of the internal space.

In some embodiments, limited by the overall appearance structure of the action camera, the internal chamber of the housing body 4 may be usually square-shaped and includes two sides and a corner between the two sides. Therefore, the bent angle between the first bent member 311 and the second bent member 312 of the reinforcement member 3 may match the angles between the inner walls of the internal spacing of the housing body 4. For example, the included angle between the first bent member 311 and the second bent member 312 may include approximately a right angle. The connection position between the first bent member 311 and the second bent member 312 may be correspondingly arranged at the angle (i.e., the corner between the two sides) formed by two adjacent inner walls of the internal chamber. As such, the reinforcement member 3 may be accommodated and fixed by sufficiently using the shape of the internal chamber of the housing body 4. Thus, the reinforcement member 3 may have a relatively long actual length in a relatively small space of the housing body 4, which may facilitate the arrangement of the FPC 2 and the transmission and reception of the radio wave.

A plurality of different switches, buttons, or other functional elements may be arranged at the housing body 4 of the action camera. These functional elements may be arranged at different positions of the housing body 4 of the action camera. Therefore, the FPC 2 may be needed to connect these functional elements to the main circuit board inside the action camera. Correspondingly, a plurality of different functional circuits may be arranged at the FPC 2. In some embodiments, a key circuit may be arranged at the FPC 2. The key circuit includes a first key 21 and a second key 22. The first key 21 and the second key 22 may include keys with different functions. The position of the first key 21 corresponds to the first bent member 311. The position of the second key 22 corresponds to the second bent member 312.

In some embodiments, the first key 21 and the second key 22 may be arranged at different positions of the housing body 4 of the action camera, for example, at outer surfaces of different directions of the housing body 4 of the action camera. Thus, correspondingly, in the key circuit of the FPC 2, the first key 21 is located at the position corresponding to the first bent member 311 of the reinforcement member 3, and the second key 22 is located at the position corresponding to the second bent member 312. As such, the portion of the FPC 2 covering the first bent member 311 and the portion of the FPC 2 covering the second bent member 312 may extend in different directions and correspondingly match the positions of the first key 21 and the second key 22, respectively. The reinforcement member 3 may support the first key 21 and the second key 22 to normally position and perform a push operation on the first key 21 and the second key 22.

In the key circuit of the FPC 2, the quantity and form of the keys may be relatively diverse. For example, the key circuit may include another key in addition to the first key 21 and the second key 22. The another key may be connected to a different portion of the FPC 2. In some other embodiments, the key circuit may include only one key. The size, structure, and type of the key may be selected according to the actual needs, which is not limited here.

In some other embodiments, the microphone circuit may be arranged at the FPC 2. The microphone circuit includes the microphone 23. The microphone 23 is arranged at the position corresponding to the first bent member 311 or the second bent member 312.

The microphone 23 may collect sound from outside via conversion between sound signal and electrical signal. The microphone 23 may be arranged at one of the first bent member 311 or the second bent member 312 of the reinforcement member 3. In some embodiments, the microphone 23 is arranged at the position corresponding to the first bent member 311. Correspondingly, a structure such as a sound pickup hole that is configured for the microphone 23 to collect the sound from the outside may be arranged at the housing body 4.

The microphone circuit and the key circuit may be arranged individually at different FPCs 2, at the same FPC 2, or by another common circuit arrangement manner, which is not repeated here.

In some embodiments, the action camera includes the housing body, the wireless communication assembly, the FPC, the reinforcement member, and the image sensor. The housing body includes the internal chamber. The image sensor, the wireless communication assembly, the FPC, and the reinforcement member may be located in the internal chamber. The reinforcement member is arranged at the FPC. The reinforcement member may include the conductive member. The reinforcement member may be electrically connected to the wireless communication assembly and be configured as the antenna radiation circuit of the wireless communication assembly. As such, the action camera may use the reinforcement member of the FPC as the antenna radiation circuit that is configured to perform the wireless communication to effectively use the structure and internal space of the action camera to cause the overall structure of the action camera to be relatively tight.

The embodiments are merely used to describe the technical solutions of the disclosure but not used to limit the disclosure. Although the disclosure is described in detail with reference to the individual embodiments, one of ordinary skill in the art should understand that it is still possible to modify the technical solutions in embodiments or to replace some or all of the technical features. However, these modifications or substitutions do not cause the essence of the corresponding technical solution to depart from the scope of the technical solutions in the individual embodiments of the disclosure.

What is claimed is:

1. An electronic apparatus comprising:
a wireless communication assembly;
a flexible printed circuit; and
a reinforcement member arranged at the flexible printed circuit and including a conductive member, the reinforcement member being electrically connected to the wireless communication assembly and configured to convert a first electrical signal from the wireless communication assembly to a radiated electromagnetic wave and convert a received electromagnetic wave to a second electrical signal for sending to the wireless communication assembly.

2. The apparatus of claim 1, wherein the flexible printed circuit and the reinforcement member are insulated from each other.

3. The apparatus of claim 1, wherein the flexible printed circuit covers at least a portion of an outer surface of the reinforcement member.

4. The apparatus of claim 1, wherein the reinforcement member includes:
a body; and
a radiation member located outside an area covered by the flexible printed circuit, one end of the radiation member being connected to the body, and another end of the radiation member including a free end extending out of the body.

5. The apparatus of claim 1, wherein:
the reinforcement member includes a plate member; and
the flexible printed circuit covers at least a portion of a plate surface of the reinforcement member.

6. The apparatus of claim 1, wherein the wireless communication assembly includes:
a circuit board; and
a wireless transceiver located at the circuit board, the reinforcement member being electrically connected to the wireless transceiver.

7. The apparatus of claim 6,
wherein the circuit board is a first circuit board;
the apparatus further comprising:
a second circuit board connected to the first circuit board via an electrical connection wire, the reinforcement member being electrically connected to the second circuit board.

8. The apparatus of claim 7, wherein:
the wireless transceiver includes a Wi-Fi transceiver; or
the second circuit board includes a main circuit board of the electronic apparatus.

9. The apparatus of claim 7, further comprising:
a conductive elastic plate arranged between the reinforcement member and the second circuit board, one end of the conductive elastic plate being connected to the reinforcement member, and another end of the conductive elastic plate abutting against a signal feed point of the second circuit board.

10. The apparatus of claim 1, further comprising:
a housing body capable of allowing an electromagnetic wave to penetrate and including:
a hollow internal chamber, the flexible printed circuit, the reinforcement member, and the wireless communication assembly being located in the internal chamber;
wherein the reinforcement member is fixed at an inner wall of the housing body.

11. An action camera comprising:
a housing body including an internal chamber;
an image sensor;
a wireless communication assembly;
a flexible printed circuit; and
a reinforcement member arranged at the flexible printed circuit and including a conductive member, the reinforcement member being electrically connected to the wireless communication assembly and configured to convert a first electrical signal from the wireless communication assembly to radiate electromagnetic wave and convert a received electromagnetic wave to a second electrical signal for sending to the wireless communication assembly;
wherein the image sensor, the wireless communication assembly, the flexible printed circuit, and the reinforcement member are located in the internal chamber.

12. The camera of claim 11, wherein the reinforcement member includes:
a first bent member; and
a second bent member connected to the first bent member, the second bent member being bent relative to the first bent member to form an included angle.

13. The camera of claim 12, wherein the first bent member and the second bent member are fixed at different inner walls of the internal chamber that face different directions.

14. The camera of claim 13, wherein:
the internal chamber of the housing body includes two sides and a corner between the two sides;
the first bent member and the second bent member are fixed at different sides of the internal chamber; and
a connection position of the first bent member and the second bent member is located at the corner of the internal chamber.

15. The camera of claim 12, wherein the flexible printed circuit covers the first bent member and the second bent member.

16. The camera of claim 15, wherein a key circuit is arranged at the flexible printed circuit and includes:
a first key arranged at a position corresponding to the first bent member; and
a second key arranged at a position corresponding to the second bent member.

17. The camera of claim 16, wherein a microphone circuit is arranged at the flexible printed circuit and includes a microphone arranged at a position corresponding to the first bent member or the second bent member.

18. The camera of claim 11, further comprising:
a first circuit board, the wireless communication assembly being arranged at the first circuit board; and
a second circuit board that is a main circuit board of the action camera.

19. The camera of claim 18, wherein the first circuit board and the second circuit board face different directions.

20. The camera of claim 18, wherein the image sensor is arranged at the second circuit board.
